(19) United States
(12) Patent Application Publication
(10) Pub. No.: US 2022/0391668 A1
(43) Pub. Date: Dec. 8, 2022

(54) METHODS AND APPARATUS TO ITERATIVELY SEARCH FOR AN ARTIFICIAL INTELLIGENCE-BASED ARCHITECTURE

(71) Applicant: INTEL CORPORATION, SANTA CLARA, CA (US)

(72) Inventors: Daniel Cummings, Austin, TX (US); Maciej Szankin, San Diego, CA (US); Sharath Nittur Sridhar, San Diego, CA (US); Anthony Sarah, San Diego, CA (US)

(21) Appl. No.: 17/845,701

(22) Filed: Jun. 21, 2022

(51) Int. Cl. G06N 3/04; G06N 3/08

(52) U.S. Cl. CPC G06N 3/04; G06N 3/08

(57) ABSTRACT

Methods, apparatus, systems, and articles of manufacture to iteratively search for an artificial intelligence-based architecture are disclosed. An example apparatus includes an interface to access a first subgroup of architecture configurations from a search space; instructions; and processor circuitry to execute the instructions to: train first predictors based on the first subgroup; generate a first plurality of candidate architecture configurations using the trained first predictors; and generate a second subgroup of architecture configurations by selecting a number of the plurality of candidate architecture configurations; train second predictors based on the first subgroup and the second subgroup; and generate a second plurality of candidate architecture configurations using the trained second predictors.

### FIELD OF THE DISCLOSURE

This disclosure relates generally to computing systems and, more particularly, to methods and apparatus to iteratively search for an artificial intelligence-based architecture.

### BACKGROUND

In recent years, artificial intelligence (AI) has increased in popularity. Artificial intelligence-based models (e.g., machine learning models, deep learning models, neural networks, etc.) are computing systems inspired by the human brain. An AI model can receive an input and generate an output. The AI model may include a plurality of neurons corresponding to weights that can be trained (e.g., can learn, be weighted, etc.) based on feedback so that outputs correspond to desired results. Once the weights are trained, the AI model can make decisions to generate an output based on an input. To train an AI-based model, training data including known inputs and known outputs can be used to teach the AI-based model how to generate a desired output based on input data. The more robust the training data, the more robust the AI-based model will be after trained.

### BRIEF DESCRIPTION OF THE DRAWINGS

FIG. 1 illustrates an example compute device to determine the quality of data shown in an example environment of use.

FIG. 2 is a block diagram of the example artificial intelligence-based searching circuitry of FIG. 1.

FIGS. 3-5 are flowcharts representative of example machine readable instructions that may be executed by example processor circuitry to implement the example artificial intelligence-based searching circuitry of FIGS. 1 and/or 2.

FIG. 6 illustrates example pseudocode corresponding to examples disclosed herein.

FIG. 7A-7C illustrate example graphs illustrating the advantages of examples disclosed herein.

FIG. 8 is a block diagram of an example processor platform including processor circuitry structured to execute the example machine readable instructions of FIGS. 3-5 to implement the example compute device of FIG. 1.

FIG. 9 is a block diagram of an example implementation of the processor circuitry of FIG. 8.

FIG. 10 is a block diagram of another example implementation of the processor circuitry of FIG. 8.

FIG. 11 is a block diagram of an example software distribution platform (e.g., one or more servers) to distribute software (e.g., software corresponding to the example machine readable instructions of FIGS. 3-5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

### DETAILED DESCRIPTION

The figures are not to scale. Instead, the thickness of the layers or regions may be enlarged in the drawings. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time+/−1 second. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events. As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

AI models, such as machine learning models, deep learning models, neural networks, etc. are used to perform a task (e.g., classify data). Implementing AI models may include facilitating a training stage to train the AI-based model using ground truth data (e.g., training data correctly labelled with a particular classification). During training, a portion of the training data may be used to tune the AI-based model to output a desired result based on an input. For example, the AI-based model obtains data that includes inputs and pre-classified outputs and the AI-based model can tune weights based on patterns of the data so that AI-based model will output the desired output based on the input data. Additionally, the AI-based model may use a separate portion of the training data to test the model to identify the accuracy of the AI-based model. If the accuracy is below a threshold, additional training data can be used to further tune the AI-based model.

As the popularity and use of AI-based models expands, the availability of different architectures for implementing AI-based models has greatly increased. Each platform has particular characteristics that may make it better for particular tasks and worse for other tasks. A Neural architecture search (NAS) protocol may be used to select an AI-based architecture for performing a particular task(s) (e.g., image classification, language conversion, etc.) in a particular(s) domain (e.g., computer vision, natural language processing, recommendation, etc.) with respect to one or more objectives(s) (e.g., optimize accuracy, latency, processor resources, memory, etc.). The NAS protocol achieves particular performance gains with results that can outperform hand-designed architectures. For example, when designing an architecture for a specific platform (e.g., a GPU), the programmer may only be interested in an accuracy objective when developing the architecture because latency is not an issue on the specific platform. However, the same architecture may have issues on a second platform due to latency. Thus, a hand-designed architecture may be limited to use on a specific platform. However, manually designing architectures that correspond to various objectives is impracticable and, in some cases, impossible. Accordingly, the NAS protocol may be used to design architectures for a particular hardware-aware model optimization task. The NAS protocol can generate a highly-diverse set of architectural configurations (e.g., sub-networks) based on a reference super-network architecture (e.g., corresponding to thousands of AI-based architectures). In this manner, the NAS protocol explores a large search space of architecture to find optimal models for a particular hardware and objective setting.

Some example NAS protocols evaluate candidate AI-based architectures via a search by training and validating each architectures one-at-a-time for a set of performance objectives. Such example NAS protocols are computationally intensive and time intensive due to the overhead of training and validation for each architecture. Some example NAS protocols attempt to lower the computation cost and time by selecting a subgroup of validated architectures (e.g., 16,000-30,000), train predictors for objectives of interest based on the subgroup of validated architectures, perform a search with the trained predictors as a surrogate for real validation measurements, and select the top performing architecture(s) from the search with respect to the objectives of interest. Although such example NAS protocols require less computation and time than validating all architectures, the computation and time for such example NAS protocols is still large.

Examples disclosed herein provide a lightweight iterative neural architecture search (LINAS) protocol that leverages that fact that lightly or weakly trained predictors (e.g., predictors trained using a small (10-50) number of architectures) give valid predictions. Accordingly, examples disclosed herein perform an iterative neural architecture search that initially samples and validates a small number (e.g., 10-50) of sub-network architectures of a search space (e.g., a super network of architectures), trains predictors based on objectives using the small number of architectures, performs an evolutionary algorithm (e.g., also referred to as an evolutionary protocol) based on objectives using the predictors to generate a plurality of candidate sub-network architecture configurations, and selects architecture configurations from the plurality based on the architecture configurations that best match the objectives. Using less than fifty one (e.g., 51) architecture configurations provides sufficient data to train a weak predictor(s) that, using examples disclosed herein, results in accurate output architecture configurations using less resources than other neural architecture search techniques. Although a higher number of architecture configurations can be used, the higher the number of candidate architectures the higher the number of validations, which results in number of resources needed to execute the LINAS protocol. Additionally, the increased accuracy associated with more than fifty (50) architectures is marginal compared to less than 50 architectures. After an initial iteration, examples disclosed herein includes the selected architecture configurations generated during previous iteration with the initial sampled sub-network architectures and a second iteration is performed. In this manner, each iteration generates predictors based on the best candidate architecture configuration from previous iterations, thereby causing the candidate architecture configurations of each subsequent iteration to more closely align with the objectives. Thus, examples disclosed herein reduce the number of computationally heavy validations needed to perform a conventional NAS protocol. Using examples disclosed herein, architecture configurations can be identified that optimize one or more objectives while only validating a fraction of the architectures than other example NAS protocols. For example, examples disclosed herein generate more optimal (e.g., lower mean absolute percentage error (MAPE) that align to one or more objectives) architectures corresponding to the one or more objectives with 250-500 validations, rather than some NAS protocols that perform over 16,000 validations. Examples disclosed herein utilizes less computational resources to identify AI-based architecture configurations that correspond to the one or more objectives. Thus, examples disclosed herein results in a fast, more accurate, and less computational approach to NAS that the other example NAS protocols.

As used herein, a super network (also referred to as a one-shot network or a weight-sharing network) is a network of architectures that provide a plurality of sub-network (e.g., sub-graph) derivative architectural networks for a specific architecture motif (e.g., ResNet, MobileNet, EfficientNet, etc.). In some examples, an evolutionary algorithm may be used to perform a search to determine optimal architectures based on trained predators. As used herein, an evolutionary algorithm and/or an evolutionary protocol is a class of block-box optimization technique that use mutation and crossover type operators to evolve a set of architectures over iterative generations. Examples of an evolutionary algorithm may include a genetic algorithm, genetic programming, evolutionary programming, evolution strategy, differential evolution, neuroevolutionary, learning classifier system, and/or any other type of population-based metaheuristic optimization algorithm.

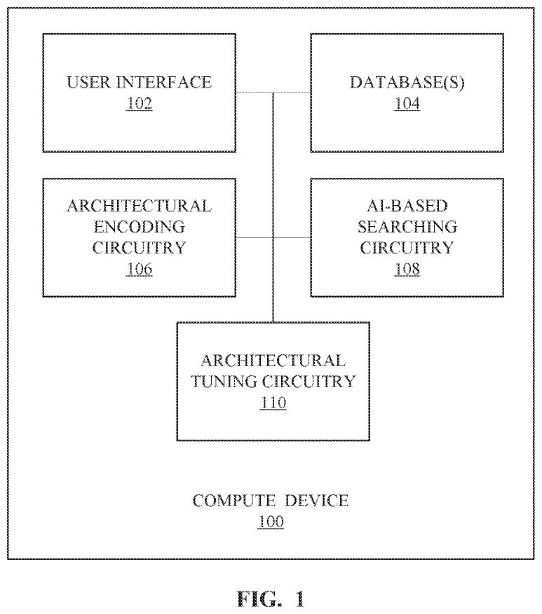

FIG. 1 is a block diagram of an example compute device 100 described in conjunction with examples disclosed herein. The example compute device 100 includes an example user interface 102, one or more example database 104, an example architectural encoding circuitry 106, example AI-based searching circuitry 108, and example architectural tuning circuitry 110.

The example user interface 102 of FIG. 1 (also referred to as user interface circuitry) obtains information corresponding to user preference for selecting an AI-based architecture for performing one or more tasks. For example, the user interface 102 allows the user to provide details related to the domain, task, and/or constraints (e.g., hyperparameters, number of layers, etc.) for identifying the AI-based architecture. In some examples, the user interface 102 displays results (e.g., output AI-based architecture configuration(s) and corresponding information) to the user. If the user has selected two or more objectives, the user interface 102 may illustrate the tradeoff between the two or more objectives for the top found architectures. The user interface 102 may further obtain user selections and/or preferences regarding the NAS protocol (e.g., how many iterations to perform, when to stop the NAS algorithm, how many sub-network architecture configurations to generate for each iteration, how many generated architecture configurations to keep for a subsequent iteration, how many architecture configurations to output after the iterations are complete, etc.). The user interface 102 may include a display and/or an input device (e.g., a touch screen, a keyboard, a mouse, etc.) for display and/or obtaining information.

The example database(s) 104 of FIG. 1 include one or more databases to store information. For example, the database(s) 104 may include a first database storing training data and a second database storing a plurality of architectures (also referred to as architecture configurations) (e.g., a super-network of architectures). In some examples, the database(s) 104 may be a single database that stores the training data and the plurality of architectures.

The example architectural encoding circuitry 106 of FIG. 1 filters out architectures stored in the database 104 based on the selected domain, task, and/or constraints. For example, if the user has indicated that they would like architectures related to image classification in computer vision, with a particular range of layers, the architectural encoding circuitry selects architectures from the database(s) 104 that correspond to the user-defined domain, task, and constraint. After selecting the candidate architectures that comply with the user-defined domain(s), task(s), and/or constraint(s), the architectural encoding circuitry 106 encodes the architectures to represent the architectures in a selected search space in a way that is cohesive with architecture selection and/or optimization (e.g., so that the AI-based searching circuitry 108 can perform a searching protocol). For example, the architectural encoding circuitry 106 encodes the candidate architectures to generate values (e.g., an array or matrix of integers) that represent the candidate architectures. The example architectural encoding circuitry 106 transmits the encoded candidate architectures to the example AI-based search circuitry 108.

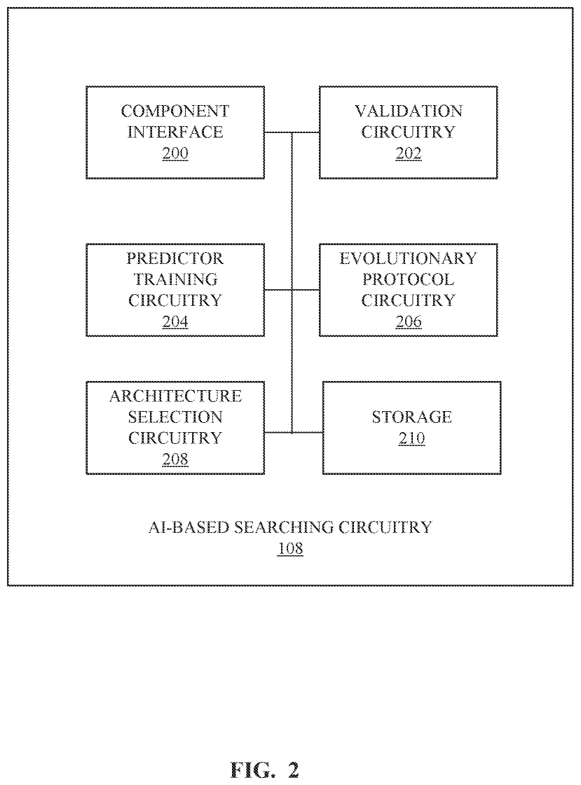

The AI-based searching circuitry 108 (e.g., also referred to as LINAS circuitry) performs an iterative NAS protocol to randomly select and/or identify X (e.g., 10-50) architectures corresponding to one or more objectives. The AI-based searching circuitry 108 obtains the encoded architectures from the architectural encoding circuitry, samples a small subgroup of the encoded architectures (10-50 architectures) and validates the subgroup of encoded architectures using the training data access from the database 104. As used herein, validating an architecture configuration includes determining one or more values corresponding to the one or objectives (e.g., latency, accuracy, resources, etc.) by using training data on the encoded architectures. For example, validating an architecture configuration may include using test data with the architecture configuration to measure an objective (e.g., accuracy, latency, etc.) corresponding to the architecture configuration. After validated the subgroup of architectures, the example AI-based searching circuitry 108 trains predictors based on the validated subgroup of architectures and one or more identified objectives. After training, the AI-based search circuitry 108 performs an iterative evolutionary algorithm using the trained predictors resulting in X number (e.g., a user and/or manufacturer defined number of architecture to keep per iteration) of architecture configurations. The example AI-based circuitry 108 then selects the architecture configurations that result in the best results (e.g., that best correspond to objectives) to include in the group of architectures used to train predictors in a subsequent iteration. Accordingly, the predictors become better (e.g., more closely aligned to the objectives) for each iteration. Because the iterative evolutionary algorithm is in the predictor space (e.g., as opposed to the validation space), the iterative search algorithm can generate thousands of candidate architecture configurations based on the predictors using significantly less resources than identifying thousands of candidate architecture from the validated space. The example AI-based searching circuitry 108 performs multiple iterations until a conditioned is satisfied, a user selects of one or more architectures, and/or after a threshold number of iterations. The example AI-based searching circuitry 108 outputs a user defined number of architectures from the iterative protocol to the example architectural tuning circuitry 110. The example AI-based searching circuitry 108 is further described below in conjunction with FIG. 2.

The example architectural tuning circuitry 110 of FIG. 1 performs fine tuning of the selected AI-based architecture(s) to increase the efficiency by adjusting and/or tuning the parameters. For example, the architecture tuning circuitry 110 can tune hyperparameters to adjust the efficiency of the selected AI-based architecture(s). In some examples, fine tuning is optional. The example architectural tuning circuitry 110 outputs the fine-tuned architecture(s) as a candidate architecture(s) for the task based on the objective(s). As described above, the user interface 102 can display the candidate architecture(s) corresponding information and/or tradeoffs between candidate architectures.

FIG. 2 is a block diagram of an example implementation of the data AI-AI-based searching circuitry 108 of FIG. 1. The AI-based searching circuitry 108 of FIG. 2 may be instantiated (e.g., creating an instance of, bring into being for any length of time, materialize, implement, etc.) by processor circuitry such as a central processing unit executing instructions. Additionally or alternatively, the AI-based searching circuitry 108 of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by one or more virtual machines and/or containers executing on the microprocessor. The example AI-based searching circuitry 108 includes an example component interface 200, example validation circuitry 202, example predictor training circuitry 204, example evolutionary protocol circuitry 206, and example architecture selection circuitry 208.

The example component interface 200 of FIG. 2 randomly obtains and/or otherwise accesses a small (e.g., 10-50 candidate architectures) subgroup of architecture configurations of the AI-based search space (e.g., the encoded architectures corresponding to the domain, task, and/or constraints) from the example architectural encoding circuitry 106 of FIG. 1. Additionally, after the output architecture(s) have been determined, the example component interface 200 provides (e.g., outputs, transmits, etc.) the output architectures to the example architectural tuning circuitry 110 of FIG. 1.

The example validation circuitry 202 of FIG. 2 validates the small sub-network of architecture configurations to measure objectives of the small-subnetwork of architecture configurations. After the small subgroup are obtained via the component interface 200, the example validation circuitry 202 validates the architectures in the subgroup using any type of validation technique. For example, the validation circuitry 202 may perform a resubstituting protocol, a train-and-test protocol, a grouped cross validation protocol, a grouped jackknife protocol, a bootstrap protocol, etc. Additionally, after a searching protocol, such as an evolutionary algorithm, is performed and the resulting top Y architecture configurations are determined, the validation circuitry 202 validates the top Y architecture configurations to generate predictors in a subsequent iteration and/or to by output to the architectural tuning circuitry 110. The example validation circuitry 202 measures and/or outputs values corresponding to objective(s) of the architecture configurations during the validation. For example, the validation circuitry 202 validates the architecture configurations by measuring one or more objectives using validation values (e.g., a value corresponding to accuracy of an architecture configuration, a value corresponding to latency of an architecture configuration, etc.). The example validation circuitry 202 may perform different measurements for different objectives. For example, the validation circuitry 202 may (a) measure the time it takes to do an inference pass for a architecture configuration to determine latency, (b) use a dataset specific test to measure a classification accuracy, etc. As described above, the objective(s) may be selected by the user. In some examples, the validation circuitry 202 stores the measured objectives into the example storage 210.

The example predictor training circuitry 204 of FIG. 2 trains predictors for each objective based on the validated architectures using the stored measured objectives. For example, during the first iteration, the predictor training circuitry 204 trains predictors based on the measured objective of the initial small sample of subnetwork architecture configurations. As used herein, trained predictors that correspond to a small subgroup of architectures are referred to as weak predictors. After each subsequent iteration, additional architecture configurations will be added to the initial small subgroup from the output of the searching protocol further described below. The example predictor training circuitry 204 may generate predictors based on various different techniques. For example, the example predictor training circuitry 204 may perform a linear regression protocol, a multi-layer perceptrons protocol, a ridge regression protocol, a gradient booting tree protocol, a support vector machine regression protocol, a stacked regression predictors protocol, etc. The different techniques may correspond to different errors depending on the objectives and/or validated architectures. Accordingly, in some examples, the predictor training circuitry 204 may evaluate, for each iteration the predictor models and/or techniques to determine which technique corresponds to the least amount of error (e.g., the mean average percentage error, mean average error, root mean square error, etc.). In this manner, the predictor training circuitry 204 can utilize different predictor techniques for different iterations to reduce error, thereby increasing the candidate architectures that are output at each iteration.

The example evolutionary protocol circuitry 206 of FIG. 2 generates sub-network architecture configurations (e.g., candidate architectures) based on the predictors. For example, the evolutionary protocol circuitry 206 may utilize an evolutionary algorithm (AE), such as a genetic algorithm, genetic programming, evolutionary programming, evolution strategy, differential evolution, neuroevolutionary, learning classifier system, and/or any other type of population-based metaheuristic optimization algorithm. The example evolutionary protocol circuitry 206 reproduces, mutates, recombines, and/or selects candidate architectures based on the trained predictors. The example evolutionary protocol circuitry 206 may determine one or more scores for the sub-network architecture configurations based on how well the configurations perform with respect to the one or more objectives and/or the error of the architectures. In some examples, the evolutionary protocol circuitry 206 ranks the generated sub-network architecture configurations in order based on the corresponding values. Because the amount of resources needed to perform the searching algorithm is significantly less than the amount of resources needed to validate architectures, the evolutionary protocol circuitry 206 can iteratively generate hundreds or thousands (e.g., based on user and/or manufacturer preferences) of sub-network architecture configurations for each iteration based on the predictors that correspond to the small number of architectures and the objectives with less resources needed than validating a large number of architectures from the search space.

The example architecture selection circuitry 208 of FIG. 2 obtains the hundreds and/or thousands of sub-network architecture configurations generated by the evolutionary protocol circuitry 206 and selects Y architectures from the sub-network architecture configurations generated by the evolutionary protocol circuitry 206 for a particular iteration for the validation circuitry 202 to validate and keep for a subsequent iteration (e.g., to train additional predictors). The example architecture selection circuitry 208 may select the Y architecture based on the error of the sub-network architecture configurations and/or how well the architecture configurations match the one or more objectives. For example, if the evolutionary protocol circuitry 206 ranks the sub-network architecture configurations, the example architecture selection circuitry 208 selects the top Y ranked sub-network architecture configurations. As described above, the validation circuitry 202 validates the selected Y architecture configurations and the output measurements corresponding to objectives from the validation of the Y validated architectures are added to the selected architectures from previous iterations and the originally sampled architectures. In some examples, the AI-based searching circuitry 108 only keeps selected sub-network architecture configurations from the last Z iterations (e.g., depending on user and/or manufacturer preferences).

The example storage 210 of FIG. 2 stores information related to the validated sub-network configurations generated by the evolutionary protocol circuitry 206 and/or the validation circuitry 202 from one or more iteration. Additionally, the example storage 210 may store predictor search results (e.g., the sub-network configurations in the predictor space), and/or the measured objectives from the validated architectures. In some examples, the storage 210 includes multiple storage components to store the different data. In some examples, the storage 210 is a single storage component to store all the different data.

While an example manner of implementing the compute device 100 of FIG. 1 is illustrated in FIG. 1 and an example manner of implementing the AI-based searching circuitry 108 of FIG. 1 is illustrated in FIG. 2, one or more of the elements, processes, and/or devices illustrated in FIGS. 1 and/or 2 may be combined, divided, re-arranged, omitted, eliminated, and/or implemented in any other way. Further, the example user interface 102, the example database(s) 104, the example architectural encoding circuitry 106, the example architectural tuning circuitry 110, the example component interface 200, the example validation circuitry 202, the example predictor training circuitry 204, the example evolutionary protocol circuitry 206, the example architecture selection circuitry 208, the example storage, and/or, more generally, the compute device 100 of FIG. 1 and/or the AI-based searching circuitry 108 of FIGS. 1-2, may be implemented by hardware, software, firmware, and/or any combination of hardware, software, and/or firmware. Thus, for example, any of the example user interface 102, the example database(s) 104, the example architectural encoding circuitry 106, the example architectural tuning circuitry 110, the example component interface 200, the example validation circuitry 202, the example predictor training circuitry 204, the example evolutionary protocol circuitry 206, the example architecture selection circuitry 208, the example storage, and/or, more generally, the compute device 100 of FIG. 1 and/or the AI-based searching circuitry 108 of FIGS. 1-2, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the AI-based searching circuitry 108 of FIGS. 1-2 is/are hereby expressly defined to include a non-transitory computer readable storage device or storage disk such as a memory, a digital versatile disk (DVD), a compact disk (CD), a Blu-ray disk, etc., including the software and/or firmware. Further still, the compute node 100 and/or the AI-based searching circuitry 108 of FIGS. 1-2 may include one or more elements, processes, and/or devices in addition to, or instead of, those illustrated in FIGS. 1-2, and/or may include more than one of any or all of the illustrated elements, processes, and devices.

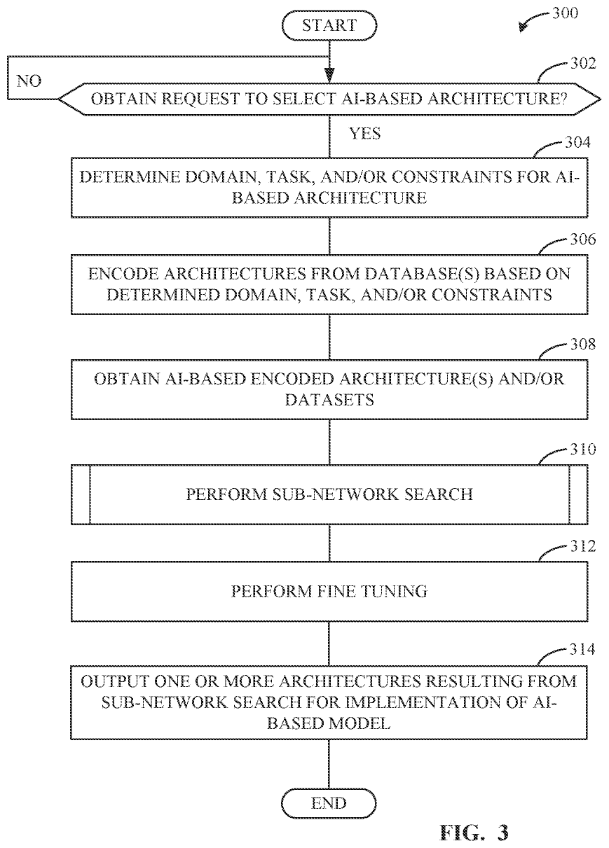

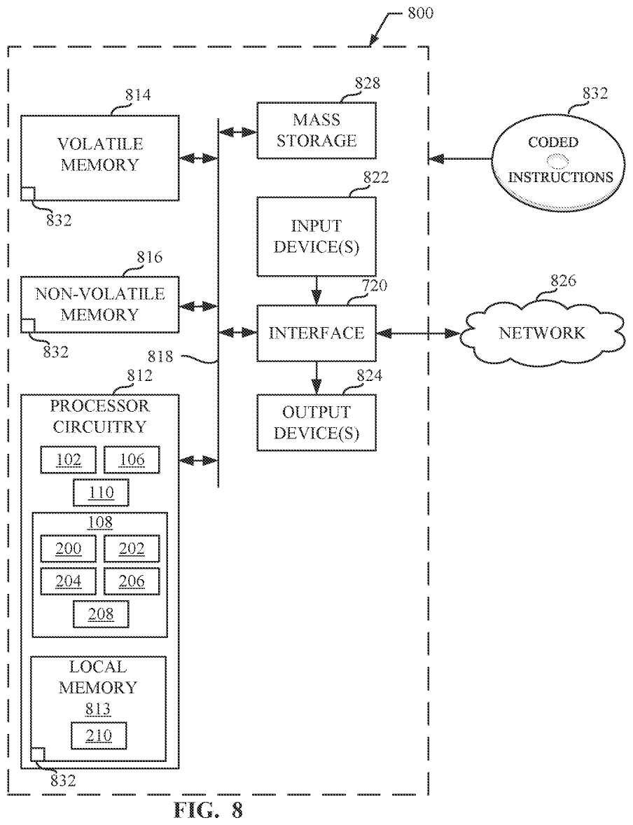

Flowcharts representative of example hardware logic circuitry, machine readable instructions, hardware implemented state machines, and/or any combination thereof for implementing the compute device 100 and/or the AI-based searching circuitry 108 are shown in FIGS. 3-5. The machine readable instructions may be one or more executable programs or portion(s) of an executable program for execution by processor circuitry, such as the processor circuitry 812 shown in the example processor platform 700 discussed below in connection with FIG. 8 and/or the example processor circuitry discussed below in connection with FIG. 8. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowchart illustrated in FIGS. 3-5, many other methods of implementing the compute device 100 and/or the AI-based searching circuitry 108 of FIGS. 1-2 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or compute devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a compute device and/or other machine. For example, the machine readable instructions may be stored in multiple parts, which are individually compressed, encrypted, and/or stored on separate compute devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular compute device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 3-5 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a,” “an,” “first”, “second”, etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 3 is a flowchart representative of example machine readable instructions and/or example operations 300 that may be executed and/or instantiated by processor circuitry (e.g., the compute device 100 and/or the example AI-based searching circuitry 108 of FIGS. 1 and/or 2) to perform an iterative neural architecture search. The instructions begin at block 302 when the example user interface 102 determines if a request to select and/or search for an AI-based architecture was obtained from a user. In some examples, a user selects the one or more domains, tasks, and/or constraints for performing an iterative neural architecture search via the example user interface 102.

At block 304, the example architectural encoding circuitry 106 determines the domain (e.g., image processing, text processing, etc.), task (e.g., classification, recommendation, conversion, etc.), and/or constraints (e.g., related to hyper parameters, number of layers, etc.) for AI-based architecture. A user and/or another device may provide the domain, task, and/or constraints for the AI-based architecture via the example user interface 102. At block 306, the example architectural encoding circuitry 106 accesses architectures that correspond to the determined domain, task, and/or constraints stored in the example database(s) 104 and encodes the accessed architectures from the example database(s) 104. As described above, the example architectural encoding circuitry 106 encodes the architecture to represent the architectures in a selected search space in a way that is cohesive with architecture selection and/or optimization. At block 308, the component interface 200 of the example AI-based searching circuitry 108 obtains the AI-based encoded architecture(s) and/or datasets from the example architectural encoding circuitry 106 and/or from the example database(s) 104. As described above, the encoded architectures that correspond to the domain, task, and/or constraints and the datasets (e.g., used to train and/or test the architectures) represent the AI-based search space for the sub-network architecture search.

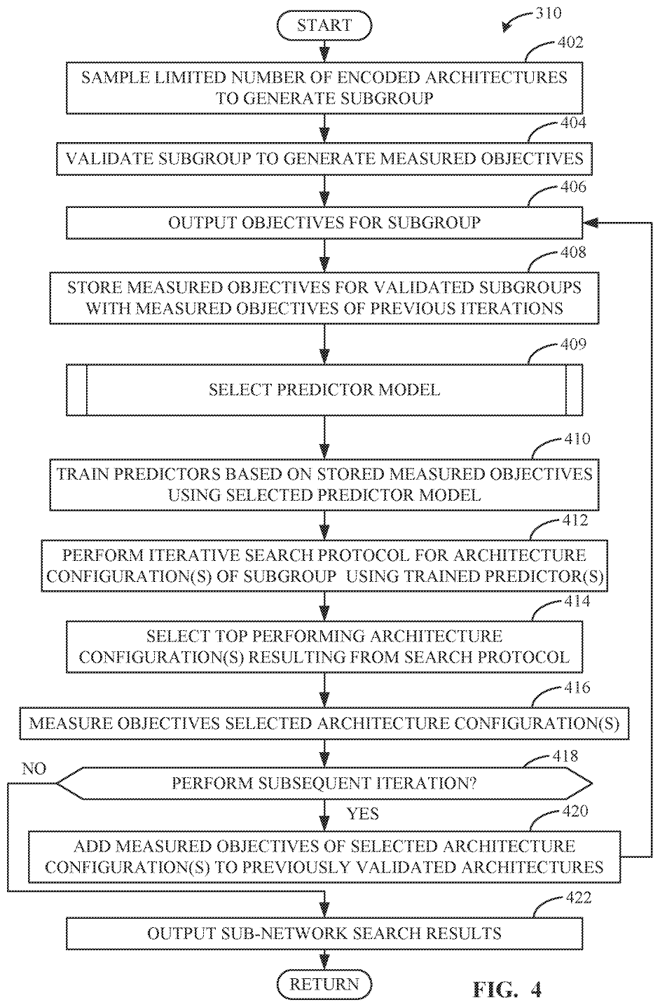

At block 310, the example AI-based searching circuitry 108 performs a sub-network search based on a small sample (e.g., 10-50) of architectures using weakly trained predictors that are based on the small sample or architectures, as further described below in conjunction with FIG. 4. At block 312, the example architectural tuning circuitry 110 performs fine tuning to push the efficiency of the output architecture(s) from the sub-network search. For examples, the architectural tuning circuitry 110 may tune the hyper parameters, the number of layers, etc. to tune the output architecture(s) so that the output architecture(s) better correspond to the objectives. At block 314, the example architectural tuning circuitry 110 outputs one or more tuned AI-based architectures resulting from the sub-network search to implement an AI-based model.

FIG. 4 is a flowchart representative of example machine readable instructions and/or example operations that may be executed and/or instantiated by processor circuitry (e.g., the AI-based searching circuitry 108 of FIG. 2) to perform a sub-network search, in conjunction with block 310 of FIG. 3. The instructions begin at block 402 when the example component interface 200 accesses a limited number of encoded architectures to generate a subgroup of architectures to generate weak predictors. As described above, the number of architectures to access for the subgroup could be between 10-50 architectures. As further described above, because validating architectures is computationally heavy, limiting the number of validations during an architectural search saves computational resources.

At block 404, the example validation circuitry 202 validates sampled and/or accessed subgroup of architectures to measured objectives (e.g., values corresponding to one or more measured objectives). For example, the validation circuitry 202 may use test data with the selected architecture configuration(s) to determine values (e.g., measured objectives) corresponding to the one or more objectives, as further described above. At block 406, the example validation circuitry 202 outputs the measured objectives for the validated subgroup. The objectives (e.g., optimize accuracy, latency, processor resources, memory, etc.) may be user and/or manufacturer defined. The example validation circuitry 202 may measure the objectives by (a) measuring the time it takes to do an inference pass for a architecture configuration to determine latency, (b) using a dataset specific test to measure a classification accuracy, etc. At block 408, the example validation circuitry 202 stores the measured objectives for the validated subgroups in the example storage 210 with the measured objectives from previous iterations. In during the first iteration, the validation circuitry 202 stores the measured objectives corresponding to the accessed subgroup.

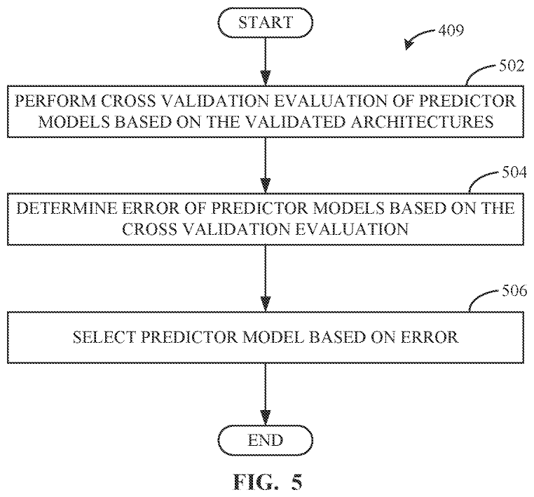

At block 409, the example predictor training circuitry 204 selects a predictor model, as further described below in conjunction with FIG. 5. As described above, different predictor models may correspond to different amounts of errors depending on the objectives and subgroups used. Accordingly, the example predictor training circuitry 204 analyzes the predictor model for each iteration to select a predictor model that provides the least amount of error for the current iteration. At block 410, the example predictor training circuitry 204 trains predictors based on the stored measured objectives using the selected predictor model. At block 412, the example evolutionary protocol circuitry 206 performs an iterative search protocol for architecture configuration(s) of the subgroup using the trained predictor(s). For example, the evolutionary protocol circuitry 206 may perform an iterative protocol, such as an evolutionary algorithm, to generate a plurality of architecture configurations based on the predictors. The number of iterations may be based on user and/or manufacturer preferences. In some examples, the evolutionary protocol circuitry 206 ranks the generated architecture configurations based on error and/or how well the architecture configurations match the objectives. In some examples, the evolutionary protocol circuitry 206 selects the Y configurations that best match the objectives. In some examples, the evolutionary protocol circuitry 206 selects Y architectures based on the error of the architectures and/or how well the architectures satisfy the objectives (e.g., the Y best architecture configurations from the iterative search protocol).

At block 414, the example architecture selection circuitry 208 selects Y architectures based on the error of the architectures and/or the performances of the architectures resulting from the evolutionary algorithm with respect to the objective(s) (e.g., the Y top architecture configurations from the iterative search protocol based how well the architectures satisfy the objectives(s)). At block 416, the example validation circuitry 202 measures objectives for the selected architecture configuration(s) (e.g., validates the selected architecture configuration(s)). For example, the validation circuitry 202 may use test data with the selected architecture configuration(s) to determine values corresponding to the one or more objectives, as further described above. At block 418, the example validation circuitry 202 determines if a subsequent interaction should be performed. In some examples, the iterations continue until a threshold number of iterations (e.g., based on user and/or manufacturer preferences) has occurred. In some examples, the interactions continue until a measured hypervolume metric with respect to a reference point reaches a threshold amount and/or does not change by a threshold amount between iterations. In such examples, the example validation circuitry 202 may determine the hypervolume metric for initially sampled subgroup of architectures for the referenced point(s) and determines the hypervolume metric based on the validated selected architecture configuration(s) of each iteration.

If the example validation circuitry 202 determines that a subsequent iteration should occur (block 418: YES), the example validation circuitry 202 adds the measured objectives of the selected architecture configuration(s) to the previously validated architectures from the prior iteration (block 420) and control returns to block 406 where the objectives are measured for the new group of architectures (e.g., the initially sampled architectures and the selected architecture configurations from the previous iteration(s)). If the example validation circuitry 202 determines that a subsequent iteration should not occur (block 418: NO), the example component interface 200 outputs the sub-network search results that corresponds to the performances (e.g., with respect to one or more objectives) of the output architecture configurations (e.g., the top performing architecture(s) based on the one or more objectives) (block 422) to the example architectural tuning circuitry 110 and control returns to block 312 of FIG. 3.

FIG. 5 is a flowchart representative of example machine readable instructions and/or example operations that may be executed and/or instantiated by processor circuitry (e.g., the AI-based searching circuitry 108 of FIG. 2) to determine the direct quality of repositories that contribute to datapoints of the training dataset, in conjunction with block 409 of FIG. 4. The example instructions begin at block 502, when the example predictor training circuitry 204 performs a cross validation evaluation of the predictor models based on the validated architectures. For example, the predictor training circuitry 204 may utilize different predictor models (e.g., a linear regression protocol, a multi-layer perceptrons protocol, a ridge regression protocol, a gradient booting tree protocol, a support vector machine regression protocol, a stacked regression predictors protocol, etc.) with the stored measured objectives corresponding to the validated architectures (e.g., the initial subgroup and the additional architectures from the previous iteration(s)) and identify the predictor model that corresponds to the least amount of error. At block 504, the example predictor training circuitry 204 determines the errors for the predictor models based on the cross validation evaluation versus the ground truth with respect to the objectives. At block 506, the example predictor training circuitry 204 selects the predictor model for the iteration based on the error (e.g., the predictor model that corresponds to the least amount of error). After block 506, control returns to block 410 of FIG. 4.

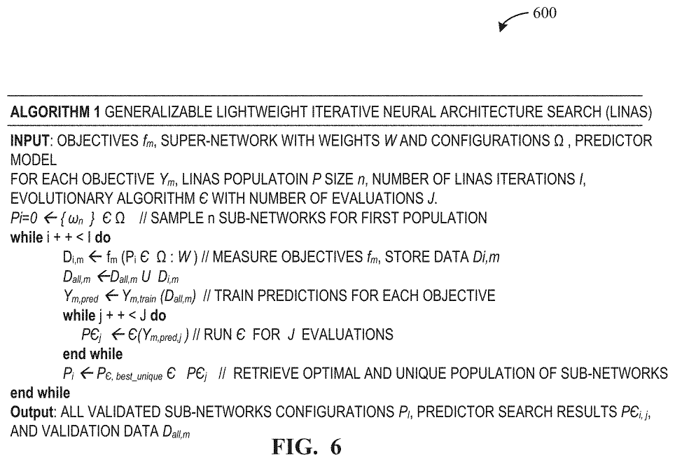

FIG. 6 illustrates example pseudocode 600 that may be executed by the example AI-based searching circuitry 108 to perform the iterative AI-based neural architectural search. In the example pseudocode 600, fm represents the input objective(s), W represents weights and/or values and Ω represents configurations corresponding to a super-network, Ym represents a predictor model for each objective, P represents an architecture population of size n used during the neural architecture search, I represents the number of iterations of the neural architecture search and J represents the number of evaluations for the evolutionary algorithm E. At the first step, the example AI-based searching circuitry 108 samples n (e.g., 10-50) sub-networks of the search space that correspond to the domain, task, and constraints selected by a user.

The first while loop of the pseudocode 600 corresponds to the number of iterations to perform. The number of iterations I may be based on user and/or manufacturer preferences. Although the number of Iterations in the example of FIG. 6 is a preset value, the number of iterations may be based on a user desire to stop the search and/or one or more values corresponding to the selected architectures satisfying a threshold. For example, if a hypervolume metric corresponding to one or more iterations satisfies a threshold and/or does not significantly change between iterations, the iterations may cease.

During an iteration, the example AI-based searching circuitry 108 measures the objectives fm for the stored architectures and stores the measured objectives with the measured objectives of the initial sample architectures and/or architectures from previous iterations (e.g., Dall,m). For the first iteration, the Dall,m is empty and the measured objectives of the sampled sub-networks are the only thing included in Dall,m. After the measured objectives of the validated architectures are added to Dall,m, the example AI-based searching circuitry 108 trains predictors for each objective using the Dall,m. After the predictors are trained for the iteration, the example AI-based searching circuitry 108 runs an evolutionary algorithm using the predicts for J evaluations. Because an evolutionary algorithm the predictor space (e.g., based on predictors) requires substantially less resources than an evaluation in the validated space, the number of evaluation and/or iterations can be in the thousands. After the AI-based searching circuitry 108 finishes the J evaluations in the evolutionary algorithm, the AI-based searching circuitry 108 obtains the Y number of unique sub-network architectures that best correspond to the objectives. These Y unique sub-network architectures for the current iteration are added to the sub-network architectures for a subsequent iteration. After the I number of search iterations are complete, the example AI-based searching circuitry 108 may output all the sub-network configurations Pi for the different iterations, the predictor search results Pεi,j and the validation data Dall,m.

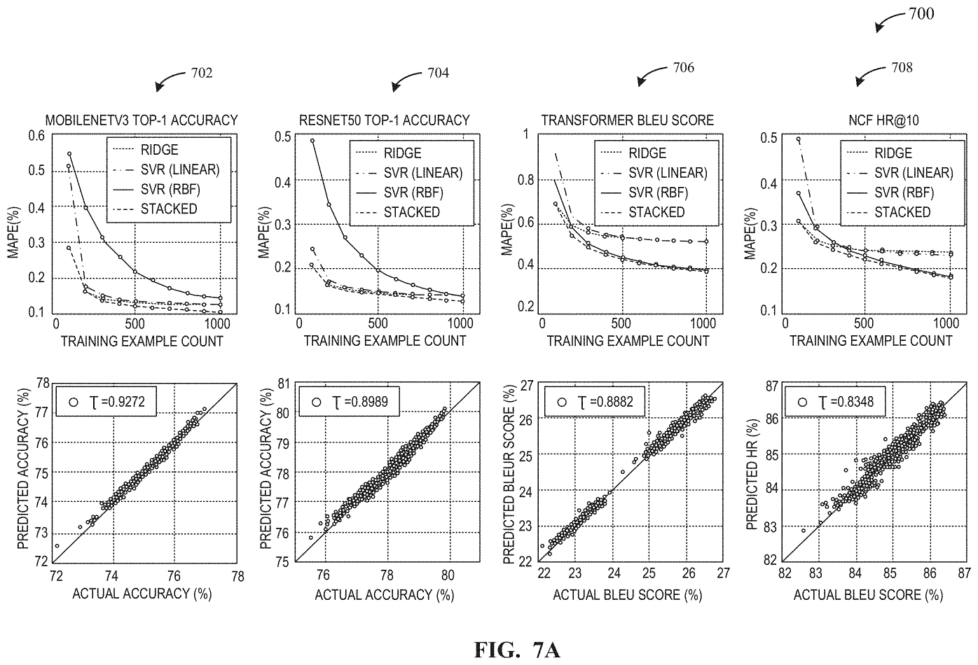

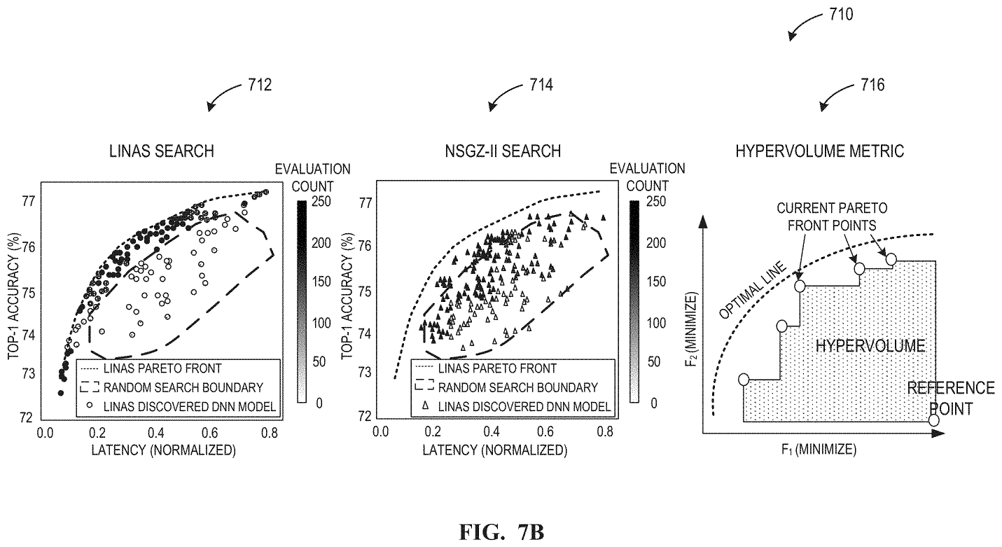

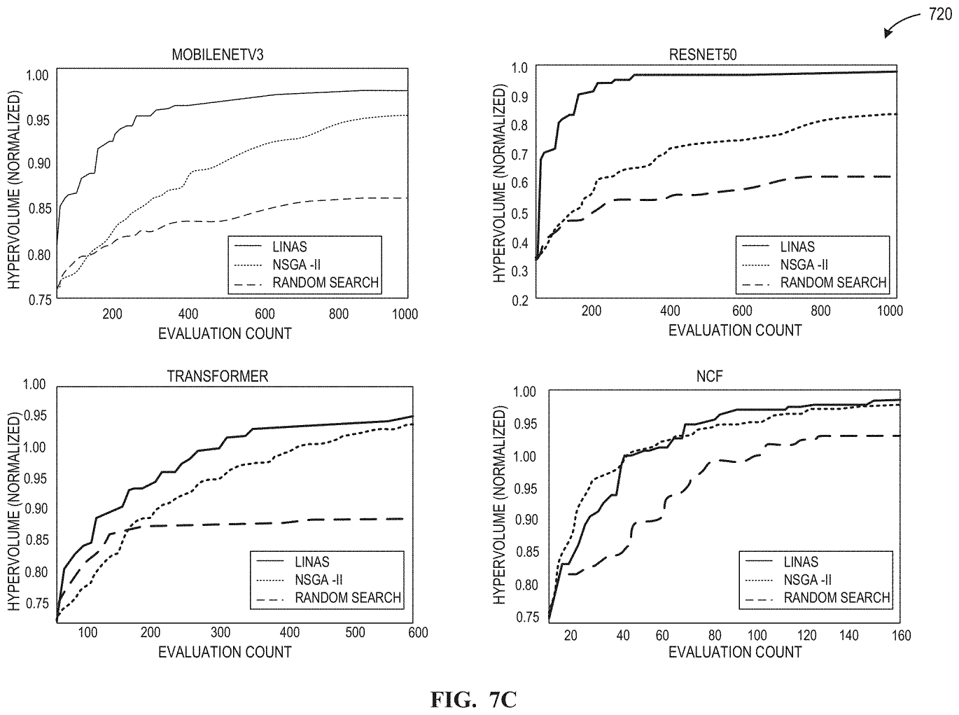

FIG. 7A illustrates example graphs 700 related to the error associated with training predictors using weak predictors. An example graphs 702 corresponds to MAPEs of predictors performing top-1 accuracy (e.g., an objective) for image classification (e.g., a task) in the computer vision field for MobileNetV3 (e.g., a specific architecture type) using an ImageNet dataset and different counts of training examples. An example graphs 704 corresponds to MAPEs of predictors performing top-1 accuracy (e.g., an objective) for image classification (e.g., a task) in the computer vision field for ResNet50 (e.g., a specific architecture type) using an ImageNet dataset and different counts of training examples. An example graphs 706 corresponds to MAPEs of predictors performing BiLingual Evaluation Understudy (BLEU) score (e.g., an objective) for machine translation (e.g., a task) for Transformer (e.g., a specific architecture type) using a WMT 2014 En-De dataset and different counts of training examples. An example graphs 708 corresponds to MAPEs of predictors performing hit rate at top-10 (HR@10) (e.g., an objective) for recommendations (e.g., a task) for neural collaborative filtering (NCF) (e.g., a specific architecture type) using a Pinterest-20 dataset and different counts of training examples.

The example graphs 700 illustrate analysis of the predictors performed over a number of different trials to account for variance in the results. In each trial, the data set for each predictor is first split into training and test sets. Subsets of the training data set within the range of 100 to 1000 examples are used to train the predictor. For a given trial, the same test set with 500 examples are used to compute the predictor absolute percentage error (MAPE). The process is repeated for a total of 100 trials and the results average to compute the MAPE shown in the graphs 700.

In the example graphs 700, the stacked predictor is a combination of ridge and support vector regression (SVR) (radial basis function (RBF)) regressors which stacks the predictions from each of the two regressors and uses them as an input to a final ridge regressor. The bottom row of graphs shows the correlation between the actual and predicted values after training the stacked predictors with 1000 examples. The Kendall rank correlation coefficient, τ, is also shown for each example. In all cases, the weak predictors provide small error (maximum MAPE of 0.91%) and high correlation (minimum τ of 0.8348) with actual values. Accordingly, FIG. 7A illustrates that weak predictors can result in low error and high correlation to actual values.

FIG. 7B illustrates example graphs 710 corresponding a comparison of examples disclosed herein (e.g., LINAS) to another example neural architecture search (e.g., a non-dominated sorting genetic algorithm-II (NSGA-II)). The example graphs 710 include example search results in a MobileNetV3 search space including an example LINAS graph 712, an example NSGA-II graph 714, and an example hypervolume metric graph 716 in the search space context graph. A dashed line is used to represent the LINAS Pareto front (e.g., the optimal accuracy vs. latency) for the architectures.

The example graphs 710 of FIG. 7B illustrate the differences between how LINAS, a random search (e.g., corresponding to the dashed circle), and NSGP-II progress in the multi-objective search space. For the same valuation count, while NSGA-II begins progressing toward an optimal trade-off region, the LINAS results show that exploration is accelerated as iterations increase. When considering the performance of LINAS across various modalities, as shown in the example graphs 712, 714, the hypervolume corresponding to LINAS quickly accelerates versus NSGA-II and a random search.

The example hypervolume metric graph 716 illustrates the performance of a multi-objective architecture search. When measuring two objectives the hypervolume term represents the dominated area of the Pareto front. Additionally, NSGA-II is not compatible with three or more objectives. Depending on which region of the Pareto front is more important (e.g., based on user and/or manufacturer preferences), an end-user would be more likely to identify optimal architectures in fewer evaluations with LINAS than with a random search or NSGA-II.

FIG. 7C include example graphs 720 that relate to hypervolume comparison between LINAS, NSGA-II, and a random search across modalities and tasks. A first example graph 722 relates to a hypervolume comparison of the different search protocols for MobileNetV3. A second example graph 724 relates to a hypervolume comparison of the different search protocols for RedNet50. A third example graph 726 relates to a hypervolume comparison of the different search protocols for Transformer. A fourth example graph 728 relates to a hypervolume comparison of the different search protocols for NCF. As shown in all of the example graphs 720, the LINAS approach consistently ranks at the top of the list with respect to hypervolume regardless of the number of evaluation counts and/or the super-network type.

The disclosed LINAS technique results in the generation of one or more optimal sub-network architectures with respect to one or more objectives. As shown above, the disclosed LINAS technique requires less resources and results in a better results then other example NAS techniques. Additionally, the disclosed LINAS technique requires less time to execute than other example NAS techniques. For example, for the MobileNetV3 super-network and a normalized hypervolume of 0.8, LINAS takes 0.48 GPU hours to complete while NSGA-II takes 1.3 hours to complete. For the MobileNetV3 super-network and a normalized hypervolume of 0.995, LINAS takes 1.75 GPU hours to complete while NSGA-II takes 9.593 hours to complete. For the ResNet50 super-network and a normalized hypervolume of 0.618, LINAS takes 0.55 GPU hours to complete while NSGA-II takes 2.44 hours to complete. For the ResNet50 super-network and a normalized hypervolume of 0.830, LINAS takes 1.43 GPU hours to complete while NSGA-II takes 9.56 hours to complete. For the Transformer super-network and a normalized hypervolume of 0.967, LINAS takes 1.88 GPU hours to complete while NSGA-II takes 3.25 hours to complete. For the Transformer super-network and a normalized hypervolume of 0.997, LINAS takes 7.9 GPU hours to complete while NSGA-II takes 10.2 hours to complete. For the NCF super-network and a normalized hypervolume of 0.965, LINAS takes 2.88 GPU hours to complete while NSGA-II takes 2.95 hours to complete. For the NCF super-network and a normalized hypervolume of 0.989, LINAS takes 4.91 GPU hours to complete while NSGA-II takes 5.3 hours to complete. Accordingly, a user or device may be able to identify that a device is implementing a LINAS technique based on the amount of GPU hours taken (e.g., compare the GPU hours taken to one or more thresholds) to perform the search and the hypervolume.

Additionally, outputs of the LINAS technique are non-correlated sub-network configurations, whereas other NAS techniques (e.g., NSGA-II) are correlated sub-network configurations. Accordingly, output configurations of LINAS are not correlated from a cross over mutation perspective. Other NAS techniques output sub-network configurations that are correlated to each other because NAS techniques select components from one architecture to another that leads to clear patterns/correlations between selected sub-network configurations. Accordingly, a user and/or device may compare the output architectures to determine how correlated the output architectures are to determine if a LINAS-based approach was performed.

FIG. 8 is a block diagram of an example processor platform 800 structured to execute and/or instantiate the machine readable instructions and/or operations of FIGS. 3-5 to implement the compute device 100 of FIG. 1 and/or AI-based searching circuitry 108 of FIG. 2. The processor platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 800 of the illustrated example includes processor circuitry 812. The processor circuitry 812 of the illustrated example is hardware. For example, the processor circuitry 812 can be implemented by one or more integrated circuits, logic circuits, FPGAs microprocessors, CPUs, GPUs, DSPs, and/or microcontrollers from any desired family or manufacturer. The processor circuitry 812 may be implemented by one or more semiconductor based (e.g., silicon based) devices. In this example, the processor circuitry 812 implements the example user interface 102, the example architectural encoding circuitry 106, the example AI-based searching circuitry 108, the example architectural tuning circuitry 110, the example component interface 200, the example validation circuitry 202, the example predictor training circuitry 204, the example architecture evolutionary protocol circuitry 206, and the example architecture selection circuitry 208 of FIG. 2.

The processor circuitry 812 of the illustrated example includes a local memory 813 (e.g., a cache, registers, etc.). In the example of FIG. 8, the example local memory 813 implements the example storage 210. Access to the main memory 814, 816 of the illustrated example is controlled by a memory controller 817. The processor circuitry 812 of the illustrated example is in communication with a main memory including a volatile memory 814 and a non-volatile memory 816 by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. The example main memory 814, 816 may implement the example database(s) 104 of FIG. 1.

The processor platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 822 are connected to the interface circuitry 820. The input device(s) 822 permit(s) a user to enter data and/or commands into the processor circuitry 812. The input device(s) 822 can be implemented by, for example, an audio sensor, a microphone, a camera (still or video), a keyboard, a button, a mouse, a touchscreen, a track-pad, a trackball, an isopoint device, and/or a voice recognition system.

One or more output devices 824 are also connected to the interface circuitry 820 of the illustrated example. The output devices 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 800 of the illustrated example also includes one or more mass storage devices 828 to store software and/or data. Examples of such mass storage devices 828 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 832, which may be implemented by the machine readable instructions of FIGS. 3-5, may be stored in the mass storage device 828, in the volatile memory 814, in the non-volatile memory 816, and/or on a removable non-transitory computer readable storage medium such as a CD or DVD.

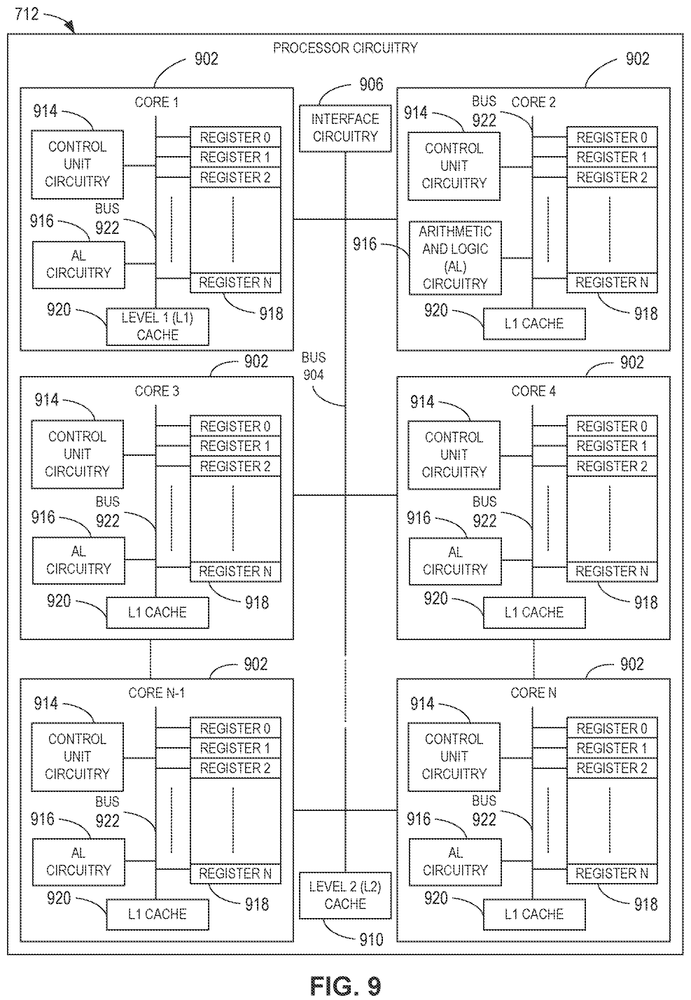

FIG. 9 is a block diagram of an example implementation of the processor circuitry 812 of FIG. 8. In this example, the processor circuitry 812 of FIG. 8 is implemented by a microprocessor 812. For example, the microprocessor 900 may implement multi-core hardware circuitry such as a CPU, a DSP, a GPU, an XPU, etc. Although it may include any number of example cores 902 (e.g., 1 core), the microprocessor 812 of this example is a multi-core semiconductor device including N cores. The cores 902 of the microprocessor 812 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowchart of FIG. 3-5.

The cores 902 may communicate by an example bus 904. In some examples, the bus 904 may implement a communication bus to effectuate communication associated with one(s) of the cores 902. For example, the bus 904 may implement at least one of an Inter-Integrated Circuit (I2C) bus, a Serial Peripheral Interface (SPI) bus, a PCI bus, or a PCIe bus. Additionally or alternatively, the bus 904 may implement any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 812 also includes example shared memory 910 that may be shared by the cores (e.g., Level 2 (L2_cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914 (e.g., control circuitry), arithmetic, and logic (AL) circuitry (sometimes referred to as an ALU) 916, a plurality of registers 918, the L1 cache 920, and an example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating point operations. In yet other examples, the AL circuitry 916 may include first AL circuitry that performs integer based operations and second AL circuitry that performs floating point operations. In some examples, the AL circuitry 916 may be referred to as an Arithmetic Logic Unit (ALU). The registers 918 are semiconductor-based structures to store data and/or instructions such as results of one or more of the operations performed by the AL circuitry 916 of the corresponding core 902. For example, the registers 918 may include vector register(s), SIMD register(s), general purpose register(s), flag register(s), segment register(s), machine specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure including distributed throughout the core 902 to shorten access time. The bus 922 may implement at least one of an I2C bus, a SPI bus, a PCI bus, or a PCIe bus.

Each core 902 and/or, more generally, the microprocessor 812 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 812 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

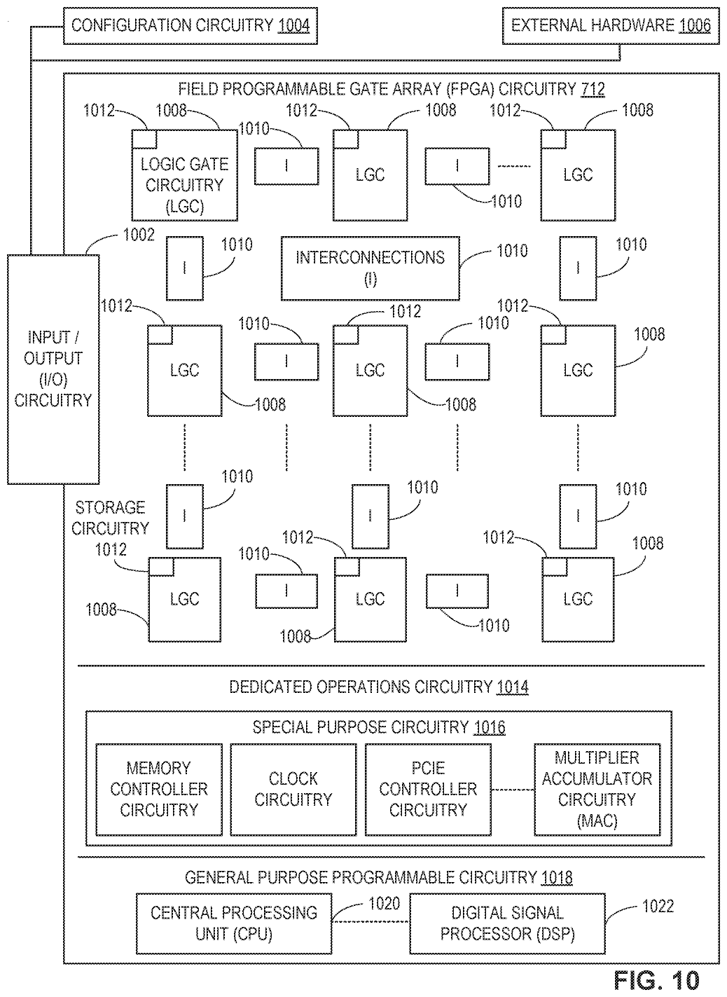

FIG. 10 is a block diagram of another example implementation of the processor circuitry 812 of FIG. 8. In this example, the processor circuitry 812 is implemented by FPGA circuitry 812. The FPGA circuitry 812 can be used, for example, to perform operations that could otherwise be performed by the example microprocessor 812 of FIG. 9 executing corresponding machine readable instructions. However, once configured, the FPGA circuitry 812 instantiates the machine readable instructions in hardware and, thus, can often execute the operations faster than they could be performed by a general purpose microprocessor executing the corresponding software.

More specifically, in contrast to the microprocessor 812 of FIG. 9 described above (which is a general purpose device that may be programmed to execute some or all of the machine readable instructions represented by the flowchart of FIG. 4-5 but whose interconnections and logic circuitry are fixed once fabricated), the FPGA circuitry 812 of the example of FIG. 10 includes interconnections and logic circuitry that may be configured and/or interconnected in different ways after fabrication to instantiate, for example, some or all of the machine readable instructions represented by the flowchart of FIG. 4-5. In particular, the FPGA 812 may be thought of as an array of logic gates, interconnections, and switches. The switches can be programmed to change how the logic gates are interconnected by the interconnections, effectively forming one or more dedicated logic circuits (unless and until the FPGA circuitry 812 is reprogrammed). The configured logic circuits enable the logic gates to cooperate in different ways to perform different operations on data received by input circuitry. Those operations may correspond to some or all of the software represented by the flowchart of FIG. 4-5. As such, the FPGA circuitry 812 may be structured to effectively instantiate some or all of the machine readable instructions of the flowchart of FIG. 4-5 as dedicated logic circuits to perform the operations corresponding to those software instructions in a dedicated manner analogous to an ASIC. Therefore, the FPGA circuitry 812 may perform the operations corresponding to the some or all of the machine readable instructions of FIG. 10 faster than the general purpose microprocessor can execute the same.

In the example of FIG. 10, the FPGA circuitry 812 is structured to be programmed (and/or reprogrammed one or more times) by an end user by a hardware description language (HDL) such as Verilog. The FPGA circuitry 812 of FIG. 10, includes example input/output (I/O) circuitry 1002 to obtain and/or output data to/from example configuration circuitry 1004 and/or external hardware (e.g., external hardware circuitry) 1006. For example, the configuration circuitry 1004 may implement interface circuitry that may obtain machine readable instructions to configure the FPGA circuitry 812, or portion(s) thereof. In some such examples, the configuration circuitry 1004 may obtain the machine readable instructions from a user, a machine (e.g., hardware circuitry (e.g., programmed, or dedicated circuitry) that may implement an Artificial Intelligence/Machine Learning (AI/ML) model to generate the instructions), etc. In some examples, the external hardware 1006 may implement the microprocessor 812 of FIG. 9. The FPGA circuitry 812 also includes an array of example logic gate circuitry 1008, a plurality of example configurable interconnections 1010, and example storage circuitry 1012. The logic gate circuitry 1008 and interconnections 1010 are configurable to instantiate one or more operations that may correspond to at least some of the machine readable instructions of FIGS. 4-5 and/or other desired operations. The logic gate circuitry 1008 shown in FIG. 10 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations. The logic gate circuitry 1008 may include other electrical structures such as look-up tables (LUTs), registers (e.g., flip-flops or latches), multiplexers, etc.

The interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 812 of FIG. 10 also includes example Dedicated Operations Circuitry 1014. In this example, the Dedicated Operations Circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 812 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the processor circuitry 812 of FIG. 8, many other approaches are contemplated. For example, as mentioned above, modern FPGA circuitry may include an on-board CPU, such as one or more of the example CPU 1020 of FIG. 10. Therefore, the processor circuitry 812 of FIG. 8 may additionally be implemented by combining the example microprocessor 812 of FIG. 9 and the example FPGA circuitry 812 of FIG. 10. In some such hybrid examples, a first portion of the machine readable instructions represented by the flowchart of FIG. 4-5 may be executed by one or more of the cores 902 of FIG. 9 and a second portion of the machine readable instructions represented by the flowchart of FIG. 4-5 may be executed by the FPGA circuitry 812 of FIG. 10.

In some examples, the processor circuitry 812 of FIG. 8 may be in one or more packages. For example, the processor circuitry 812 of FIG. 9 and/or the FPGA circuitry 812 of FIG. 10 may be in one or more packages. In some examples, an XPU may be implemented by the processor circuitry 812 of FIG. 8, which may be in one or more packages. For example, the XPU may include a CPU in one package, a DSP in another package, a GPU in yet another package, and an FPGA in still yet another package.

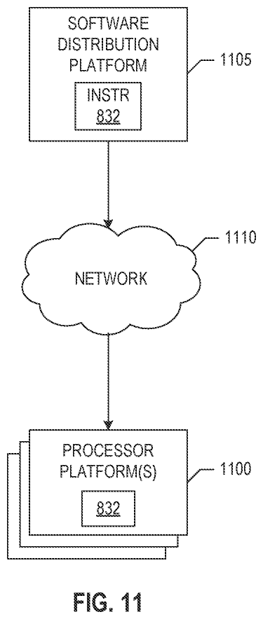

A block diagram illustrating an example software distribution platform 1105 to distribute software such as the example machine readable instructions 832 of FIG. 8 to hardware devices owned and/or operated by third parties is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine readable instructions 832 of FIG. 8. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine readable instructions 832, which may correspond to the example machine readable instructions 300, 400, 500 of FIGS. 3-5, as described above. The one or more servers of the example software distribution platform 1105 are in communication with a network 1110, which may correspond to any one or more of the Internet and/or any example network. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 832 from the software distribution platform 1105. For example, the software, which may correspond to the example machine readable instructions 300, 400, 500 of FIG. 4-5, may be downloaded to the example processor platform 800, which is to execute the machine readable instructions 832 to implement the AI-based searching circuitry 108. In some example, one or more servers of the software distribution platform 1105 periodically offer, transmit, and/or force updates to the software (e.g., the example machine readable instructions 832 of FIG. 8) to ensure improvements, patches, updates, etc., are distributed and applied to the software at the end user devices.

Example methods, apparatus, systems, and articles of manufacture to iteratively search for an artificial intelligence-based architecture are disclosed herein. Further examples and combinations thereof include the following: Example 1 includes an apparatus to perform an architecture search, the apparatus comprising an interface to access a first subgroup of architecture configurations from a search space, instructions, and processor circuitry to execute the instructions to train first predictors based on the first subgroup, generate a first plurality of candidate architecture configurations using the trained first predictors, generate a second subgroup of architecture configurations by selecting a number of the first plurality of candidate architecture configurations, and train second predictors based on the first subgroup and the second subgroup, and generate a second plurality of candidate architecture configurations using the trained second predictors.

Example 2 includes the apparatus of example 1, wherein the processor circuitry is to measure a first objective of the first subgroup and a second objective of the first subgroup, and train the first predictors based on the first and second objectives.

Example 3 includes the apparatus of example 1, wherein the processor circuitry is to train the first predictors using a first predictor model and train the second predictors using a second predictor model different than the first predictor model.

Example 4 includes the apparatus of example 3, wherein the processor circuitry is to select the first predictor model based on an error of the first predictor model.

Example 5 includes the apparatus of example 1, wherein the processor circuitry is to generate the first plurality of candidate architecture configurations using an evolutionary protocol.

Example 6 includes the apparatus of example 1, wherein the processor circuitry is to generate the first plurality of candidate architecture configurations during a first iteration, generate the second plurality of candidate architecture configurations during a second iteration, and stop performing iterations based on a hypervolume metric corresponding to generated architecture configurations corresponding to the second iteration.

Example 7 includes the apparatus of example 1, wherein the first subgroup of architecture configurations includes less than fifty one architecture configurations.

Example 8 includes a non-transitory computer readable medium comprising instructions which, when executed, cause one or more processors to at least train first predictors using a first subgroup of architecture configurations, perform a first evolutionary protocol to generate a first plurality of candidate architecture configurations using the trained first predictors, select a second subgroup of the first plurality of candidate architecture configurations based on performances of the candidate architecture configurations, and train second predictors using the first subgroup and the second subgroup, and perform a second evolutionary protocol to generate a second plurality of candidate architecture configurations using the trained second predictors.

Example 9 includes the computer readable medium of example 8, wherein the instructions cause the one or more processors to measure a first objective of the first subgroup and a second objective of the first subgroup, and train the first predictors based on the first and second objectives.

Example 10 includes the computer readable medium of example 8, wherein the instructions cause the one or more processors to train the first predictors using a first predictor model and train the second predictors using a second predictor model different than the first predictor model.

Example 11 includes the computer readable medium of example 10, wherein the instructions cause the one or more processors to select the first predictor model based on an error of the first predictor model.

Example 12 includes the computer readable medium of example 8, wherein the instructions cause the one or more processors to generate the first plurality of candidate architecture configurations using an evolutionary protocol.

Example 13 includes the computer readable medium of example 8, wherein the instructions cause the one or more processors to generate the first plurality of candidate architecture configurations during a first iteration, generate the second plurality of candidate architecture configurations during a second iteration, and stop performing iterations based on a hypervolume metric corresponding to generated architecture configurations corresponding to the second iteration.

Example 14 includes the computer readable medium of example 8, wherein the first subgroup of architecture configurations includes less than fifty one architecture configurations.

Example 15 includes an apparatus to perform an architecture search, the apparatus comprising interface circuitry to access a first subgroup of architecture configurations from a search space, and processor circuitry including one or more of at least one of a central processing unit, a graphics processing unit or a digital signal processor, the at least one of the central processing unit, the graphics processing unit or the digital signal processor having control circuitry, one or more registers, and arithmetic and logic circuitry to perform one or more first operations corresponding to instructions in the apparatus, and, a Field Programmable Gate Array (FPGA), the FPGA including logic gate circuitry, a plurality of configurable interconnections, and storage circuitry, the logic gate circuitry and interconnections to perform one or more second operations, or Application Specific Integrated Circuitry (ASIC) including logic gate circuitry to perform one or more third operations, the processor circuitry to perform at least one of the first operations, the second operations or the third operations to instantiate predictor training circuitry to train first predictors based on the first subgroup, evolutionary protocol circuitry to generate a first plurality of candidate architecture configurations using the first subgroup, architecture selection circuitry to generate a second subgroup of architecture configurations by selecting a number of the first plurality of candidate architecture configurations, the predictor training circuitry to train second predictors based on the first subgroup and the second subgroup, and the evolutionary protocol circuitry to generate a second plurality of candidate architecture configurations using the trained second predictors.

Example 16 includes the apparatus of example 15, further including validation circuitry to measure a first objective of the first subgroup and a second objective of the first subgroup, the predictor training circuitry to train the first predictors based on the first and second objectives.

Example 17 includes the apparatus of example 15, wherein the predictor training circuitry to train the first predictors using a first predictor model and train the second predictors using a second predictor model different than the first predictor model.

Example 18 includes the apparatus of example 17, wherein the predictor training circuitry is to select the first predictor model based on an error of the first predictor model.

Example 19 includes the apparatus of example 15, wherein the evolutionary protocol circuitry is to generate the first plurality of candidate architecture configurations using an evolutionary protocol.

Example 20 includes the apparatus of example 15, wherein the predictor training circuitry is to generate the first plurality of candidate architecture configurations during a first iteration, generate the second plurality of candidate architecture configurations during a second iteration, and stop performing iterations based on a hypervolume metric corresponding to generated architecture configurations corresponding to the second iteration.

Example 21 includes the apparatus of example 15, wherein the first subgroup of architecture configurations includes less than fifty one architecture configurations.

Example 22 includes an apparatus to perform an architecture search, the apparatus comprising means for training first predictors based on a first subgroup of architecture configurations from a search space, means for generating a first plurality of candidate architecture configurations using the first subgroup of architecture configurations from the search space, means for selecting a second subgroup of the candidate architecture configurations, the means for training to train second predictors based on the first subgroup and the second subgroup, and the means for generating to generate a second plurality of candidate architecture configurations using the trained second predictors.

Example 23 includes the apparatus of example 22, further including means for measuring a first objective of the first subgroup and a second objective of the first subgroup, the means for training to train the first predictors based on the first and second objectives.

Example 24 includes the apparatus of example 22, wherein the means for training to train the first predictors using a first predictor model and train the second predictors using a second predictor model different than the first predictor model.

Example 25 includes the apparatus of example 24, wherein the means for selecting to select the first predictor model based on an error of the first predictor model.

Example 26 includes the apparatus of example 22, wherein the means for generating is to generate the first plurality of candidate architecture configurations using an evolutionary protocol.

Example 27 includes the apparatus of example 22, wherein the means for generating is generate the first plurality of candidate architecture configurations during a first iteration, generate the second plurality of candidate architecture configurations during a second iteration, and stop performing iterations based on a hypervolume metric corresponding to generated architecture configurations corresponding to the second iteration.

Example 28 includes the apparatus of example 22, wherein the first subgroup of architecture configurations includes less than fifty one architecture configurations.

Example 29 includes a method to perform an architecture search, the method comprising training, by executing an instruction with one or more processors, first predictors using a first subgroup of architecture configurations, generating, by executing an instruction with the one or more processors, a first plurality of candidate architecture configurations using the trained first predictors, selecting, by executing an instruction with the one or more processors, a second subgroup of the first plurality of candidate architecture configurations based on performances of the candidate architecture configurations, and training, by executing an instruction with the one or more processors, second predictors using the first subgroup and the second subgroup, and generating, by executing an instruction with the one or more processors, a second plurality of candidate architecture configurations using the trained second predictors.

Example 30 includes the method of example 29, further including measuring a first objective of the first subgroup and a second objective of the first subgroup, and training the first predictors based on the first and second objectives.

Example 31 includes the method of example 29, further including train the first predictors using a first predictor model and train the second predictors using a second predictor model different than the first predictor model.

Example 32 includes the method of example 31, further including selecting the first predictor model based on an error of the first predictor model.

Example 33 includes the method of example 29, further including generating the first plurality of candidate architecture configurations using an evolutionary protocol.

Example 34 includes the method of example 29, further including generating the first plurality of candidate architecture configurations during a first iteration, generating the second plurality of candidate architecture configurations during a second iteration, and ceasing execution of iterations based on a hypervolume metric corresponding to generated architecture configurations corresponding to the second iteration.

Example 35 includes the method of example 29, wherein the first subgroup of architecture configurations includes less than fifty one architecture configurations.

From the foregoing, it will be appreciated that example systems, methods, apparatus, and articles of manufacture have been disclosed that iteratively search for an artificial intelligence-based architecture. Examples disclosed herein utilize an iterative neural architecture search based on weak predictors that results in substantially less computationally heavy validations than conventional neural architecture search techniques. Accordingly, examples disclosed herein result in a more efficient neural architectural search that is faster, more accurate (e.g., with respect to objectives), and requires less computational resources (e.g., processor resources, memory, etc.) than conventional techniques. Disclosed systems, methods, apparatus, and articles of manufacture are accordingly directed to one or more improvement(s) in the operation of a machine such as a computer or other electronic device.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

The following claims are hereby incorporated into this Detailed Description by this reference, with each claim standing on its own as a separate embodiment of the present disclosure.

1. An apparatus to perform an architecture search, the apparatus comprising:
an interface to access a first subgroup of architecture configurations from a search space;
instructions; and
processor circuitry to execute the instructions to:
train first predictors based on the first subgroup;
generate a first plurality of candidate architecture configurations using the trained first predictors;
generate a second subgroup of architecture configurations by selecting a number of the first plurality of candidate architecture configurations; and
train second predictors based on the first subgroup and the second subgroup; and
generate a second plurality of candidate architecture configurations using the trained second predictors.

2. The apparatus of claim 1, wherein the processor circuitry is to:
measure a first objective of the first subgroup and a second objective of the first subgroup; and
train the first predictors based on the first and second objectives.

3. The apparatus of claim 1, wherein the processor circuitry is to train the first predictors using a first predictor model and train the second predictors using a second predictor model different than the first predictor model.

4. The apparatus of claim 3, wherein the processor circuitry is to select the first predictor model based on an error of the first predictor model.

5. The apparatus of claim 1, wherein the processor circuitry is to generate the first plurality of candidate architecture configurations using an evolutionary protocol.

6. The apparatus of claim 1, wherein the processor circuitry is to:
generate the first plurality of candidate architecture configurations during a first iteration;
generate the second plurality of candidate architecture configurations during a second iteration; and
stop performing iterations based on a hypervolume metric corresponding to generated architecture configurations corresponding to the second iteration.

7. The apparatus of claim 1, wherein the first subgroup of architecture configurations includes less than fifty one architecture configurations.

8. A non-transitory computer readable medium comprising instructions which, when executed, cause one or more processors to at least:
train first predictors using a first subgroup of architecture configurations;
perform a first evolutionary protocol to generate a first plurality of candidate architecture configurations using the trained first predictors;
select a second subgroup of the first plurality of candidate architecture configurations based on performances of the candidate architecture configurations; and
train second predictors using the first subgroup and the second subgroup; and
perform a second evolutionary protocol to generate a second plurality of candidate architecture configurations using the trained second predictors.

9. The computer readable medium of claim 8, wherein the instructions cause the one or more processors to:
measure a first objective of the first subgroup and a second objective of the first subgroup; and
train the first predictors based on the first and second objectives.

10. The computer readable medium of claim 8, wherein the instructions cause the one or more processors to train the first predictors using a first predictor model and train the second predictors using a second predictor model different than the first predictor model.

11. The computer readable medium of claim 10, wherein the instructions cause the one or more processors to select the first predictor model based on an error of the first predictor model.

12. The computer readable medium of claim 8, wherein the instructions cause the one or more processors to generate the first plurality of candidate architecture configurations using an evolutionary protocol.

13. The computer readable medium of claim 8, wherein the instructions cause the one or more processors to:
generate the first plurality of candidate architecture configurations during a first iteration;
generate the second plurality of candidate architecture configurations during a second iteration; and
stop performing iterations based on a hypervolume metric corresponding to generated architecture configurations corresponding to the second iteration.

14. The computer readable medium of claim 8, wherein the first subgroup of architecture configurations includes less than fifty one architecture configurations.

15. An apparatus to perform an architecture search, the apparatus comprising:
interface circuitry to access a first subgroup of architecture configurations from a search space; and
processor circuitry including one or more of:
at least one of a central processing unit, a graphics processing unit or a digital signal processor, the at least one of the central processing unit, the graphics processing unit or the digital signal processor having control circuitry, one or more registers, and arithmetic and logic circuitry to perform one or more first operations corresponding to instructions in the apparatus, and;
a Field Programmable Gate Array (FPGA), the FPGA including logic gate circuitry, a plurality of configurable interconnections, and storage circuitry, the logic gate circuitry and interconnections to perform one or more second operations; or
Application Specific Integrated Circuitry (ASIC) including logic gate circuitry to perform one or more third operations;
the processor circuitry to perform at least one of the first operations, the second operations or the third operations to instantiate:
predictor training circuitry to train first predictors based on the first subgroup;
evolutionary protocol circuitry to generate a first plurality of candidate architecture configurations using the first subgroup;
architecture selection circuitry to generate a second subgroup of architecture configurations by selecting a number of the first plurality of candidate architecture configurations;
the predictor training circuitry to train second predictors based on the first subgroup and the second subgroup; and
the evolutionary protocol circuitry to generate a second plurality of candidate architecture configurations using the trained second predictors.

16. The apparatus of claim 15, further including validation circuitry to measure a first objective of the first subgroup and a second objective of the first subgroup, the predictor training circuitry to train the first predictors based on the first and second objectives.

17. The apparatus of claim 15, wherein the predictor training circuitry to train the first predictors using a first predictor model and train the second predictors using a second predictor model different than the first predictor model.

18. The apparatus of claim 17, wherein the predictor training circuitry is to select the first predictor model based on an error of the first predictor model.

19. The apparatus of claim 15, wherein the evolutionary protocol circuitry is to generate the first plurality of candidate architecture configurations using an evolutionary protocol.

20. The apparatus of claim 15, wherein the predictor training circuitry is to:
generate the first plurality of candidate architecture configurations during a first iteration;
generate the second plurality of candidate architecture configurations during a second iteration; and
stop performing iterations based on a hypervolume metric corresponding to generated architecture configurations corresponding to the second iteration.

21. The apparatus of claim 15, wherein the first subgroup of architecture configurations includes less than fifty one architecture configurations.

22. (canceled)

23. (canceled)

24. (canceled)

25. (canceled)

26. (canceled)

27. (canceled)

28. (canceled)

29. A method to perform an architecture search, the method comprising:
training, by executing an instruction with one or more processors, first predictors using a first subgroup of architecture configurations;
generating, by executing an instruction with the one or more processors, a first plurality of candidate architecture configurations using the trained first predictors;
selecting, by executing an instruction with the one or more processors, a second subgroup of the first plurality of candidate architecture configurations based on performances of the candidate architecture configurations; and
training, by executing an instruction with the one or more processors, second predictors using the first subgroup and the second subgroup; and
generating, by executing an instruction with the one or more processors, a second plurality of candidate architecture configurations using the trained second predictors.

30. The method of claim 29, further including:
measuring a first objective of the first subgroup and a second objective of the first subgroup; and
training the first predictors based on the first and second objectives.

31. The method of claim 29, further including train the first predictors using a first predictor model and train the second predictors using a second predictor model different than the first predictor model.

32. The method of claim 31, further including selecting the first predictor model based on an error of the first predictor model.

33. (canceled)

34. (canceled)

35. (canceled)
